(19) United States
(12) Patent Application Publication
(10) Pub. No.: US 2010/0230359 A1
(43) Pub. Date: Sep. 16, 2010

(54) POROUS AND DURABLE CERAMIC FILTER MONOLITH COATED WITH A RARE EARTH FOR REMOVING CONTAMINANTS FROM WATER

(75) Inventors: Charles F. Whitehead, Las Vegas, NV (US); Timothy L. Oriard, Issaquah, WA (US)

Correspondence Address: SHERIDAN ROSS PC, 1560 BROADWAY, SUITE 1200, DENVER, CO, 80202, US

(73) Assignee: MOLYCORP MINERALS, LLC, Greenwood Village, CO (US)

(21) Appl. No.: 12/725,114

(22) Filed: Mar. 16, 2010

Related U.S. Application Data
(60) Provisional application No. 61/160,611, filed on Mar. 16, 2009.
(60) Provisional application No. 61/160,620, filed on Mar. 16, 2009.
(60) Provisional application No. 61/246,342, filed on Sep. 28, 2009.

(51) Int. Cl. B01D 39/20; B01D 29/00; B01D 15/00; B01J 20/02

(52) U.S. Cl. 210/679; 210/502.1; 427/244; 210/435; 210/335; 210/340

(57) ABSTRACT

The invention is directed generally to a porous and durable ceramic filter monolith coated with one or more rare earth-containing compositions for removing contaminants from a fluid, particularly for removing one or more contaminants from water.

### CROSS REFERENCE TO RELATED APPLICATIONS

The present application claims the benefit of U.S. Provisional Application Nos. 61/160,611, entitled “Porous and Durable Ceramic Filter Monolith Coated with Cerium Oxide for Removing Contaminantes from Water” filed on Mar. 16, 2009, 61/160,620 entitled “Process for Removing Arsenic from Aqueous Streams” filed on Mar. 16, 2009, and 61/246,342 entitled “Apparatus and Process for Treating an Aqueous Solution Containing Organic Materials” filed on Sep. 28, 2009, the entire contents of each is incorporated herein by this reference in its entirety.

### FIELD OF INVENTION

This invention is directed generally to a porous and durable ceramic filter monolith coated with one or more rare earth-containing compositions for removing contaminants from a fluid, particularly for removing one or more contaminants from water.

### BACKGROUND OF THE INVENTION

Globally, access to clean air and potable water are limited by multiple factors. The presence of contaminants such as arsenic, viruses or micro-organisms could make a water supply unsuitable for human consumption. Furthermore, the presence of chemical and industrial contaminants, viruses, fungi, bacteria or other micro-organisms within the atmosphere could make breathing of the air unhealthy. A variety of health crises can result from the consumption of contaminated water and/or the breathing of contaminated air.

Arsenic is a toxic element that naturally occurs in a variety of combined forms in the earth. Its presence in natural waters may originate, for example, from geochemical reactions, industrial waste discharges and past agricultural uses of arsenic-containing pesticides. Because the presence of high levels of arsenic may have carcinogenic and other deleterious effects on living organisms, the U.S. Environmental Protection Agency (EPA) and the World Health Organization have set the maximum contaminant level (MCL) for arsenic in drinking water at 10 parts per billion (ppb). Arsenic concentrations in wastewaters, groundwaters, surface waters and geothermal waters frequently exceed this level. Thus, the current MCL and any future decreases, which may be to as low as 2.0 ppb, create the need for new techniques to economically and effectively remove arsenic from drinking water, well water and industrial waters.

Basic methods used to remove contaminants from liquid and/or gaseous fluids have included physical filtration, absorption on solid sorbents such as activated carbon, electrostatic precipitation, chemical conversion, and treatment with various forms of radiation including heat, ultraviolet light and microwave. Filtration methods tend to be limited by the pore size of the filters, and are generally not capable of removing many biological and chemical contaminants. Moreover, ultra small pore sizes and clogging due to particulates on the filter can cause an unacceptable pressure drop across the filter for many applications. Electrostatic precipitation of particles works by charging the particles and then removing them from the fluid onto a charged surface such as on a collection plate. This technique is not suitable for high velocity fluid streams, fluids containing volatile chemical contaminants or contaminants that are otherwise difficult to charge. Chemical reaction is impractical for many applications, such as with large volume fluid streams. Heating, although effective for removing many types of biological and chemical contaminants from a fluid, tends to be ineffective on higher velocity fluid streams. Ultraviolet light is also effective but can be difficult to implement on larger fluid volumes as the light tends to only be effective on those contaminants in the portion of the fluid stream immediately adjacent the light source.

When specifically matched to one or both of the fluid and contaminant, sorbents can effective for contaminant removal. For example, activated carbon requires that carbon particle characteristics be matched to contaminant properties to be adsorbed.

What is needed is a composition and method for removing a diverse set of biological and chemical contaminants such as bacteria, viruses, nerve agents, blister agents, pesticides, insecticides and other highly toxic chemical agents from various fluid streams. Furthermore, the composition and/or method should be easily incorporated into a variety of fluid treating apparatuses and/or processes.

Cerium oxide can be used to remove contaminants from a fluid stream. For example, U.S. Pat. Nos. 6,863,825 and 7,338,603, each of which is incorporated herein in its entirety by this reference. U.S. Pat. No. 6,863,825 to Witham et al. discloses a process for removing arsenic from aqueous streams using cerium. U.S. Pat. No. 7,338,603 to McNew et al. discloses a process for removing oxyanions from aqueous streams using rare earths. U.S. patent application Ser. Nos. 11/932,837, 11/932,702, 11/931,616, and 11/932,543 all filed Oct. 31, 2007, each of which is incorporated herein in its entirety by this reference. U.S. application Ser. No. 11/932,837 to Burba et al. discloses an apparatus for treating flow of an aqueous solution containing a contaminant, such as, arsenic. U.S. application Ser. No. 11/932,702 to Burba discloses a composition and process for making the composition, more particularly to aggregate compositions suitable for use in treating fluids that contain one or more contaminants, in particular one or more chemical and/or biological contaminants. U.S. application Ser. No. 11/932,616 to Burba et al. discloses a process and apparatus for removing and deactivating bacteria and viruses in a fluid, particularly an aqueous fluid. U.S. application Ser. No. 11/932,543 to Burba et al. discloses a process and apparatus for treating a fluid, in particular treating a solution to remove and/or detoxify one or more contaminants in the solution.

### SUMMARY OF THE INVENTION

One aspect of the present invention is an apparatus comprising a permeable monolith having a plurality of interconnected pores, fluid ingress and egress surfaces and an insoluble rare earth composition within the interconnected pores. The ingress and egress surfaces are in fluid communication via the interconnected pores. The interconnected pores permit a contaminant-containing fluid to flow through the interconnected pores. The interconnected pores have an average pore size from about 0.05 μm to about 1.0 μm. The contaminated fluid enters the apparatus through the ingress surface and discharges through the egress surface.

The solid rare earth composition is preferably in any suitable form, such as an insoluble solid, a coating, a particle, a nano-particle, a sub-micron particle, and/or a powder. The insoluble solid may be interconnected by a polymeric binder and/or coating. Optionally, the rare earth composition contains one or more of a flow aid and a fixing agent. The insoluble rare earth composition is preferably in the form of an oxygen-containing rare earth composition, more preferably in the form of a rare earth oxide or oxo composite. In one application, the insoluble solid is a lanthanoid, particularly cerium. The cerium is typically in the form of a cerium (IV) oxide or a cerium species, which, for example, can be a cerium (III) and/or (IV) salt.

In a preferred embodiment, the solid rare earth composition is in the form of an insoluble rare earth composition. More specifically, the solid rare composition is insoluble in the fluid stream. Preferably, the insoluble rare earth composition comprises from about 1 wt % to about 65 wt % of the monolith containing the solid rare earth composition. The wt % of the monolith containing the insoluble rare earth composition is determine as by the following formula (I):

wt % insoluble rare earth=100*(wt insoluble rare earth contained by monolith)/(wt monolith+wt of solid rare earth composition contained by monolith) (1)

More preferably, from about 10 wt % to about 40 wt % of the rare earth coated monolith comprises the insoluble rare earth composition. Even more preferably, the wt % of the insoluble rare earth composition is from about 15 to about 25 wt % of the rare earth coated monolith containing the solid rare earth composition.

Preferably, the insoluble rare earth composition contained by the monolith in the form of one or both of a film and/or a plurality of particles. In one embodiment, the insoluble rare earth composition may have an average film thickness from about 0.5 nm to about 500 nm. Preferably, the insoluble rare earth composition average film thickness is from about 2 nm to about 50 nm. Even more preferably, the average film thickness of the insoluble rare earth composition is from about 3 nm to about 20 nm.

Preferably, the plurality of insoluble rare earth composition particles has an average surface area of at least about 1 m²/g. Depending upon the application, higher average surface areas may be desired. Specifically, the insoluble rare earth particulates may have a surface area of at least about 5 m²/g, in other cases more than about 10 m²/g, in other cases more than about 70 m²/g, in other cases more than about 85 m²/g, in still other cases more than 115 m²/g, and in yet other cases more than about 160 m²/g. In addition, it is envisioned that the insoluble rare earth particulates with higher surface areas will be more effective. One skilled in the art will recognize that the surface area of the insoluble rare earth particle will impact the fluid dynamic properties within the monolith containing the insoluble rare earth particles. As a result, there may be a need to balance benefits derived from increased particle surface areas with fluid dynamics, such as any pressure drop that may occur.

The contaminant is removed from the contaminant-containing fluid by the insoluble rare earth composition. The insoluble rare earth composition need not be limited to a single insoluble rare earth-containing compound but can include two or more insoluble rare earth-containing compounds. Such compounds can contain the same or different rare earth elements and can contain mixed valence or oxidation states. The insoluble rare earth-containing compound comprises one or more rare earths including lanthanum, cerium, praseodymium, neodymium, promethium, samarium, europium, gadolinium, terbium, dysprosium, holmium erbium, thulium, ytterbium and lutetium. In some embodiments, the insoluble rare-earth containing compound comprises one or more of cerium, lanthanum, or praseodymium. Preferably, the insoluble rare earth composition comprises cerium. By way of example, when the insoluble rare earth-containing compound comprises cerium, the composition preferably comprises one or more cerium oxides such as CeO₂(IV) and Ce₂O₃(III). In embodiments where the insoluble rare earth-containing compound comprises a cerium oxide, CeO₂ is generally preferred for its substantial insolubility in water and relatively attrition resistance in fluids. Insoluble rare earth-containing compounds are available commercially and may be obtained from any source or through any process known to those skilled in the art.

In an embodiment, the insoluble rare earth-containing compound is derived from precipitation of a rare earth salt. In another embodiment, the insoluble rare earth-containing compound is derived from a rare earth carbonate, nitrate, sulfate, anionic halogen oxide (such as XO₃—, where X is one of chlorine, bromine or iodine) or a rare earth oxalate.

In preferred embodiment where the insoluble rare earth-containing compound comprises a cerium-containing compound, the cerium-containing compound can be derived from precipitation of a cerium salt. In another embodiment, the insoluble cerium-containing compound is derived from a cerium carbonate, cerium nitrate, cerium sulfate, cerium anionic halogen oxide (such as XO₃—, where X is one of chlorine, bromine or iodine) or a cerium oxalate. In a preferred embodiment, the insoluble cerium-containing compound can be prepared by thermally decomposing one of a cerium carbonate, cerium nitrate, cerium sulfate, cerium chlorate, cerium bromated, cerium iodate, or cerium oxalate at a temperature between about 250° C. and about 900° C., preferably from about 300° C. to about 700° C. in a furnace in the presence of air. Even more preferably, the thermal decomposition temperature for forming the insoluble cerium containing-compound is from about 500 degrees Celsius to about 700 degrees Celsius. Optionally, the insoluble cerium containing-compound is acid treated and/or washed to remove any carbonate, nitrate, sulfate, chlorate, iodate, bromate, and/or oxalate contained within and/or associated with the insoluble cerium-containing compound. In yet another embodiment, that the insoluble rare earth-containing compound can be derived from a rare earth carbonate, rare earth nitrate, rare earth sulfate, rare earth anionic halogen oxide (such as, ClO₃—, BrO₃— and/or IO₃—), or rare earth oxalate as described above for the corresponding cerium salts.

The monolith comprises a ceramic material. The ceramic material is one of an inorganic crystalline oxide material, inorganic non-crystalline oxide material or a combination thereof. Preferably, the ceramic material is one or more of quartz, feldspar, kaolin clay, china clay, clay, alumina, silica, mullite, silicate, kaolinite, ball clay, bone ash, steatite, petuntse, alabaster, zirconia, carbide, boride, silicide, and combinations thereof. More preferably, the ceramic material comprises one of silica, alumina and a combination thereof.

In a preferred embodiment, the monolith is sufficiently coated with the rare earth-containing composition to one or both remove enough of one or more of contaminants from the fluid to form the purified fluid stream and to maintain sufficient fluid flow through the insoluble rare earth-coated monolith. That is in a preferred embodiment, the rare earth-containing monolith provides one or more of: fluid flow through the rare earth-containing monolith, minimal pressure drop, and contaminant removal efficiency.

Preferably, the rare earth-containing monolith comprises a continuous phase filtering element having opposing ingress and egress fluid surfaces. One advantage of the rare earth-containing monolith is that it does not require a filtering step to separate the monolith from the fluid stream. In a preferred embodiment, the rare earth-containing monolith comprises a porous and/or permeable ceramic monolith. The porous and/or preamble ceramic monolith can remove suspended particulate solids from the aqueous stream with little, if any, pressure build-up. Yet another embodiment of the invention includes, during operational use of the monolith, a cleaning step to remove solid particulates trapped by the monolith.

In another embodiment, the rare earth-containing monolith comprises materials that are chemically and/or physically durable. Chemical and/or physical durability means the monolith does not substantially degrade and/or decompose during a period of operation. Preferably, the period of operation without substantial degradation and/or decomposition is at least about 2 years, more preferably at least about 5 years and even more preferably at least about 10 years. Even more, preferably the monolithic does not substantially degrade and/or decompose for a period of operation of at least about 20 years.

Another aspect of the present invention is a method comprising contacting a monolith having a plurality of interconnected pores with a rare earth-containing solution to form a rare earth impregnated monolith and calcining the impregnated monolith to form a rare earth coated monolith. The interconnected pores form a plurality of fluid pathways. The rare earth coated monolith has a plurality of rare earth coated pathways. The rare earth coating the pathways is in the form of an insoluble rare earth composition.

The rare earth-containing solution is impregnated along substantially the entire lengths of the fluid pathways. The rare earth-containing solution is one of a rare earth carbonate, nitrate, iodate, sulfate, chlorate, bromate, acetate, formate, and oxalate. Preferably, the rare earth-containing solution comprises one of cerium carbonate, nitrate, iodate, sulfate, chlorate, bromate, acetate, formate, and oxalate. In a preferred embodiment, the rare earth-containing solution is an aqueous solution.

In one embodiment, the contacting is one of spray coating, curtain coating, immersing, kiss-coating, and coating under greater than atmospheric pressure. Preferably, the monolith is immersed in the rare earth-containing solution. The period of time the monolith is immersed in the rare earth-containing solution is from about 1 hour to about 48 hours.

The method optionally includes drying the impregnated monolith, after the contacting step and before the calcining step, to form a dried rare film within the interconnected pores of the monolith. Preferably, the drying period is from about 10 minutes to about 24 hours.

The calcining step forms an insoluble rare earth composition within at least some, if not most or all, of the interconnected pores of the monolith. The calcining step comprises heating the monolith to a temperature of from about 250 degrees Celsius to about 900 degrees Celsius. Preferably, the monolith is heated in the presence of oxygen and/or air.

Yet another aspect of the present invention is a process comprising contacting an ingress surface of a porous monolith having an insoluble rare earth composition with a contaminant-containing fluid and passing the contaminant-containing fluid through the monolith to an egress surface where a purified fluid exits therefrom. The passing of the contaminant-containing fluid through the monolith substantially removes one or more contaminants contained within the contaminant-containing fluid to form the purified fluid and a contaminant-loaded rare earth composition. Preferably, the process further comprises one or both of applying heat and pressure before and/or during the contacting of the contaminant-containing fluid with the ingress surface. The one or more contaminants contained within the contaminant-containing solution are removed by the insoluble rare earth composition. At least one of the one or more contaminants is one of a chemical contaminant, biological contaminant, microbe, microorganism and a mixture thereof. The contaminant-containing fluid is one of a liquid fluid, a gaseous fluid, and a combination of liquid and gaseous fluids.

In one embodiment, the contaminant-loaded rare earth comprises REX and/or REOX. In a preferred embodiment, the contaminant-loaded rare earth composition comprises cerium, preferably one of CeX and/or CeOX, and combinations thereof. RE comprises one of lanthanum, cerium, praseodymium, neodymium, promethium, samarium, europium, gadolinium, terbium, dysprosium, holmium erbium, thulium, ytterbium and lutetium and O comprises O²⁻. X may comprise one or more of: arsenic, an arsenate, an oxyanion, an organic phosphate, a carboxylate, a denature protein, a halide, a fluoride, an amine, an organoamine, a pesticide and/or a residue of the pesticide, a warfare agent and/or a residue of the warfare agent, a nerve agent and/or a residue of the nerve agent, a pharmaceutical and/or a residue of the pharmaceutical, a biological agent and/or a residue of the residue biological agent, a micro-organism and/or a residue of the micro-organism, and a virus and/or a residue of the virus. The term residue means a chemical and/or a structure fragment of the agent and/or chemical. When the contaminant comprises arsenic, X is AsO₄²⁻ and the contaminant-loaded rare earth comprises REAsO₄, more preferably, when the fluid stream comprises water, REAsO₄.(H₂O)_{X}, where 0<X≦10.

Still yet another aspect of the present invention is a system comprising: a container having a housing and a porous and permeable monolith disposed within the hosing, the porous and permeable monolith has an ingress surface interconnected with an egress surface by a plurality of fluid pathways extending through the porous monolith. The porous and permeable monolith has an insoluble rare earth composition within the interconnected pathways for removing one or more contaminants from a contaminant-containing fluid to form a purified fluid. The contaminant-containing fluid flows from the inlet and through the ingress surface, the plurality of fluid pathways, and the egress surface for discharge of the purified fluid through the outlet. The ingress and egress surfaces are in fluid communication through the interconnected pathways of the monolith. Any contacting of the purified and contaminant-containing fluids is within the interconnected pathways of the monolith. That is, the contaminant-containing fluid contacts the ingress surface and not the egress surface and/or the purified fluid.

The porous and permeable monolith has opposing first and second ends, an inlet, an outlet, and an outer wall extending between the first and second ends enclosing a fluid flow path between the inlet and the outlet. The ingress surface is operably interconnected to the inlet and the egress surface is operably connected to the outlet. In one configuration, the container has one or more monoliths configured in series, parallel and any combination thereof. Preferably, the container comprises one of a metal, plastic, PVC, and acrylic.

As used herein, fluid means one a liquid phase, a gas phase or a two-phase system containing both liquid and gas phases. As used herein, gas phase means the components comprising the fluid may expand indefinitely, are separated from one another and have free paths, define neither a volume nor a shape, and may be compressed. As used herein, a liquid means the components comprising the fluid move freely, are free to flow, substantially resists compression, has a surface tension value, and defines a volume, however, the volume need not have a definite shape.

The term “contaminant” means one a “chemical contaminant” “biological contaminant”, “microbe”, “microorganism” and mixtures thereof.

The term “chemical contaminant” comprises, without limitation metals, metalloids, oxyanions, chemical warfare agents, industrial chemicals and materials, pesticides, nerve agents, pharmaceuticals, insecticides, herbicides, rodenticides, and fertilizers. The terms “biological contaminant”, “microbe”, “microorganism”, and the like include bacteria, fungi, protozoa, viruses, algae and other biological entities and pathogenic species that can be found in a fluid.

In one embodiment, the disclosed apparatus and process effectively removes arsenic from fluids containing particularly high concentrations of contaminants. The disclosed apparatus and process are effective in decreasing the contaminants to levels safe for human exposure to the fluid (such as, for human consumption and/or inhalation of the fluid). For example, the when fluid contains arsenic the disclosed apparatus and process effectively decreases the arsenic level to amounts less than about 20 ppb, in some cases less than about 10 ppb, in others less than about 5 ppb and in still others less than about 2 ppb.

In another embodiment, the disclosed apparatus and process effectively removes biological contaminants from fluids containing particularly high concentrations of the biological contaminants. The apparatus and process can effectively decrease one or more biological contaminants contained within the contaminant-containing fluid by from about 1 Log₁₀ to about 10 Log₁₀, more preferably from about 3 Log₁₀ to about 7 Log₁₀. Even more preferably from about 4 Log₁₀ to about 6 Log₁₀.

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

It will be understood that a composition, process, apparatus or article as described herein can be used to remove, deactivate and/or detoxify biological and chemical contaminants in a fluid. Non-limiting examples of suitable fluids are aqueous liquids and breathable gases such as air. There may be a need to treat fluids containing such contaminants in open environments such as on the battlefield, in remove or insolated locations, in enclosed spaces such as in buildings or similar structures, within vehicles such as airplanes, space craft, ships or military vehicles, and wherever such contaminants may be found. The described processes, apparatuses and articles can be used to remove, deactivate or detoxify such contaminants from fluids having diverse volume and flow rate characteristics and can be applied in variety of fixed, mobile and portable applications.

The terminology “remove” or “removing” includes the sorption, precipitation, conversion and killing of pathogenic and other microorganisms, such as bacteria, viruses, fungi and protozoa and chemical contaminants that may be present in a gas.

The terms “deactivate” or “deactivation”, “de-toxify” or “de-toxification” and “neutralize” include rendering a biological or chemical contaminant non-pathogenic or benign to humans or other animals such as for example by killing the microorganisms or converting the chemical agent into a non-toxic form or species.

As used herein, “absorption” refers to the penetration of one substance into the inner structure of another, as distinguished from adsorption.

As used herein, “adsorption” refers to the adherence of atoms, ions, molecules, polyatomic ions, or other substances of a gas or liquid to the surface of another substance, called the adsorbent. The attractive force for adsorption can be, for example, ionic, covalent, or electrostatic forces, such as van der Waals and/or London's forces.

As used herein, a “composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

As used herein, “insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little (<5%) loss of mass.

As used herein, “oxyanion” or oxoanion is a chemical compound with the generic formula AₓO_{y}^{z-} (where A represents a chemical element other than oxygen and O represents an oxygen atom). In target material-containing oxyanions, “A” represents metal, metalloid, and/or Se (which is a non-metal), atoms. Examples for metal-based oxyanions include chromate, tungstate, molybdate, aluminates, zirconate, etc. Examples of metalloid-based oxyanions include arsenate, arsenite, antimonate, germanate, silicate, etc.

As used herein, “particle” refers to a solid or microencapsulated liquid having a size that ranges from less than one micron to greater than 100 microns, with no limitation in shape.

As used herein, “precipitation” refers not only to the contaminant removal in the form of an insoluble species but also to contaminant immobilization an on or in an insoluble composition. For example, “precipitation” includes processes, such as adsorption and absorption.

As used herein, “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

As used herein, “soluble” refers to materials that readily dissolve in water. For purposes of this invention, it is anticipated that the dissolution of a soluble compound would necessarily occur on a time scale of minutes rather than days. For the compound to be considered to be soluble, it is necessary that it has a significantly high solubility product such that upwards of 5 g/L of the compound will be stable in solution.

As used herein, “sorb” refers to adsorption and/or absorption.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Furthermore, as used herein, “one or more of” and “at least one of” when used to preface several elements or classes of elements such as X, Y and Z or X₁—Xₙ, Y₁—Y₁ and Z₁—Zₙ, is intended to refer to a single element selected from X or Y or Z, a combination of elements selected from the same class (such as X₁ and X₂), as well as a combination of elements selected from two or more classes (such as Y₁ and Zₙ).

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

These and other advantages will be apparent from the disclosure of the invention(s) contained herein.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples.

Further features and advantages will become apparent from the following, more detailed, description of the various embodiments of the invention(s), as illustrated by the drawings referenced below.

FIG. 1 depicts the chemical structure of humic acid;

FIG. 2 depicts a process for making an apparatus according to an embodiment of the present invention;

FIG. 3 depicts a process for using an apparatus made by the process of FIG. 2 according to another embodiment of the present invention;

FIG. 4 depicts non-limiting examples of suitable shapes of the apparatus of FIG. 2; and

FIG. 5 depicts percent of humic acid retention on ceria-coated alumina according to Example I.

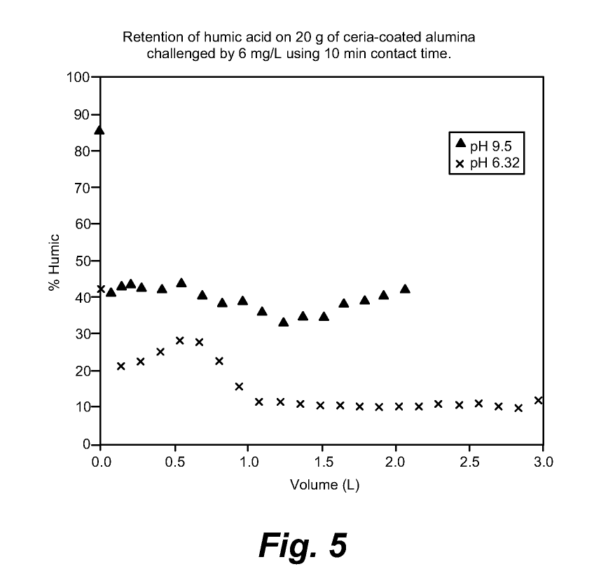

### DETAILED DESCRIPTION OF THE INVENTION

One aspect of the present invention is an apparatus for removing one or more contaminants from a fluid stream. The fluid stream may comprise one of a liquid phase, gas phase, or two-phase stream having liquid and gaseous phases. In a preferred embodiment, the fluid stream comprises an aqueous fluid stream. In another preferred embodiment, the fluid stream comprises a gaseous stream. The gaseous stream can comprise a breathable gaseous stream, such as air.

The one or more contaminant comprises at least one of a chemical contaminant, a chemical warfare agent, a biological contaminant, a microbe, a microorganism and a mixture thereof. The chemical contaminant may comprise, without limitation metals, metalloids, oxyanions, chemical warfare agents, industrial chemicals and materials, pesticides, nerve agents, pharmaceuticals, insecticides, herbicides, rodenticides, and fertilizers.

The metal and metalloid contaminants comprise, without limitation: arsenic, antimony, aluminum, cadmium, bismuth, zinc, tin, titanium, selenium, tellurium, mercury, polonium, lead, indium, germanium, gallium, chromium, nickel, copper, cobalt and the oxyanions thereof.

The chemical warfare agent comprise, without limitation, organosulfur-based compounds such as 2,2′-dichlorodiethyl sulfide (HD, mustard, mustard gas, S mustard or sulfur mustard), which are known as “blister” or “blistering” agents and can be lethal in high doses. Other chemical warfare agents include organophosphorus-based (“OP”) compounds, such as O-ethyl S-(2-diisopropylamino)ethyl methylphosphonothiolate (VX), 2-propyl methylphosphonofluoridate (GB or Sarin), and 3,3′-Dimethyl-2-butyl methylphosphonolluoridate (GD or Soman), which are commonly referred to as “nerve” agents because they attack the central nervous system and can cause paralysis and potentially death in a short period of time. Moreover, chemical contaminants comprise, without limitation, o-alkyl phosphonofluoridates, such as o-alkyl phosphoramidocyanidates, such as tabun, o-alkyl, s-2-dialkyl aminoethyl alkylphosphonothiolates and corresponding alkylated or protonated salts, such as VX, mustard compounds including, 2-chloroethylchloromethylsulfide, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether, Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine, saxitoxin, ricin, alkyl phosphonyldifluoride, alkyl phosphonites, chlorosarin, parathion, paraoxon, chlorosoman, amiton, 1,1,3,3,3-pentafluoro-2-(trifluoromethyl)-1-propene, 3-quinuclidinyl benzilate, methylphosphonyl dichloride, dimethyl methylphosphonate, dialkyl phosphoramide dihalides, alkyl phosphoramidates, diphenyl hydroxyacetic acid, quinuclidin-3-ol, dialkyl aminoethyl-2-chlorides, dialkyl aminoethane-2-ols, dialkyl aminoethane-2-thiols, thiodiglycols, pinacolyl alcohols, phosgene, cyanogen chloride, hydrogen cyanide, chloropicrin, phosphorous oxychloride, phosphorous trichloride, phosphorus pentachloride, alkyl phosphorous oxychloride, alkyl phosphites, phosphorous trichloride, phosphorus pentachloride, alkyl phosphites, sulfur monochloride, sulfur dichloride, a tannin, humic acid, and thionyl chloride.

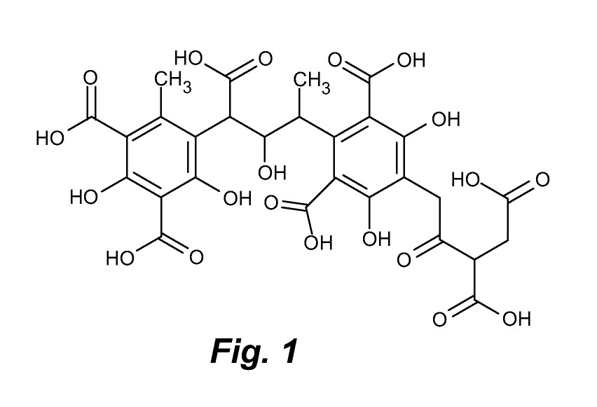

Humic acid (depicted in FIG. 1) is a complex polycyclic compound. Humic acid is believed to be a degradation product of lignin. Lignin belongs to a family of polyphenols derived from the dehydroxylation of plant sugars.

Furthermore, the industrial chemicals and materials, pesticides, herbicides, and rodenticids comprise materials that have anionic functional groups such as phosphates, sulfates and nitrates, and electro-negative functional groups, such as chlorides, fluorides, bromides, ethers and carbonyls. Specific non-limiting examples can include acetaldehyde, acetone, acrolein, acrylamide, acrylic acid, acrylonitrile, aldrin/dieldrin, ammonia, aniline, arsenic, atrazine, barium, benzidine, 2,3-benzofuran, beryllium, 1,1′-biphenyl, bis(2-chloroethyl)ether, bis(chloromethyl)ether, bromodichloromethane, bromoform, bromometliane, 1,3-butadiene, 1-butanol, 2-butanone, 2-butoxyethanol, butraldehyde, carbon disulfide, carbon tetrachloride, carbonyl sulfide, chlordane, chlordecone and mirex, chlorfenvinphos, chlorinated dibenzo-p-dioxins (CDDs), chlorine, chlorobenzene, chlorodibenzofurans (CDFs), chloroethane, chloroform, chloromethane, chlorophenols, chlorpyrifos, cobalt, copper, creosote, cresols, cyanide, cyclohexane, DDT, DDE, DDD, DEHP, di(2-ethylhexyl)phthalate, diazinon, dibromochloropropane, 1,2-dibromoethane, 1,4-dichlorobenzene, 3,3′-dichlorobenzidine, 1,1-dichloroethane, 1,2-dichloroethane, 1,1-dichloroethene, 1,2-dichloroethene, 1,2-dichloropropane, 1,3-dichloropropene, dichlorvos, diethyl phthalate, diisopropyl methylphosphonate, di-n-butylphtalate, dimethoate, 1,3-dinitrobenzene, dinitrocresols, dinitrophenols, 2,4- and 2,6-dinitrotoluene, 1,2-diphenylhydrazine, di-n-octylphthalate (DNOP), 1,4-dioxane, dioxins, disulfoton, endosulfan, endrin, ethion, ethylbenzene, ethylene oxide, ethylene glycol, ethylparathion, fenthions, fluorides, formaldehyde, freon 113, heptachlor and heptachlor epoxide, hexachlorobenzene, hexachlorobutadiene, hexachlorocyclohexane, hexachlorocyclopentadiene, hexachloroethane, hexamethylene diisocyanate, hexane, 2-hexanone, HMX (octogen), hydraulic fluids, hydrazines, hydrogen sulfide, iodine, isophorone, malathion, MBOCA, methamidophos, methanol, methoxychlor, 2-methoxyethanol, methyl ethyl ketone, methyl isobutyl ketone, methyl mercaptan, methylparathion, methyl t-butyl ether, methylchloroform, methylene chloride, methylenedianiline, methyl methacrylate, methyl-tert-butyl ether, mirex and chlordecone, monocrotophos, N-nitrosodimethylamine, N-nitrosodiphenylamine, N-nitrosodi-n-propylainine, naphthalene, nitrobenzene, nitrophenols, perchloroethylene, pentachlorophenol, phenol, phosphamidon, phosphorus, polybrominated biphenyls (PBBs), polychlorinated biphenyls (PCBs), polycyclic aromatic hydrocarbons (PAHs), propylene glycol, phthalic anhydride, pyrethrins and pyrethroids, pyridine, RDX (cyclonite), selenium, styrene, sulfur dioxide, sulfur trioxide, sulfuric acid, 1,1,2,2-tetrachloroethane, tetrachloroethylene, tetryl, thallium, tetrachloride, trichlorobenzene, 1,1,1-trichloroethane, 1,1,2-trichloroethane, trichloroethylene (TCE), 1,2,3-trichloropropane, 1,2,4-trimethylbenzene, 1,3,5-trinitrobenzene, 2,4,6-trinitrotoluene (TNT), vinyl acetate, and vinyl chloride.

The biological contaminant comprises one or more of microbe, microorganism, bacteria, fungi, protozoa, viruses, algae and other biological entities and pathogenic species that can be found in a fluid. Specific non-limiting examples of biological contaminants can include bacteria such as Escherichia coli, Streptococcus faecalis, Shigella spp, Leptospira, Legimella pneumophila, Yersinia enterocolitica, Staphylococcus aureus, Pseudomonas aeruginosa, Klebsiella terrigena, Bacillus anthracis, Vibrio cholerae and Salmonella typhi, viruses such as hepatitis A, noroviruses, rotaviruses, and enteroviruses, protozoa such as Entamoeba histolytica, Giardia, Cryptosporidium parvum and others. Specific non-limiting examples of viruses that may be effectively removed by the disclosed apparatus and processes, include without limitation: dsDNA virsuses; ssDNA viruses; dsRNA viruses; (+)ssRNA virsus; (−) ssRNA virsuses; ssRNA-RT viruses; dsDNA-RT viruses; adenoviruses, herpesviruses, proxviruses, parvovirsuses, reoviruses, picornaviruses, togaviruses, orthomyxoviruses, phabdoviruses, retroviruses, hpadnaviruses, varicella zosert, ebola viruses, AIDS viruses, SARS viruses, herpes viruses, hepatitis viruses, papillomaviures, Epstein-Barr viruses, T-lymphotropic viruses, and mrsa viruses. Biological contaminants can also include various species such as fungi or algae that are generally non-pathogenic but which are advantageously removed. Non-limiting to the invention is how such biological contaminants come to be present in the fluid, either through natural occurrence or through intentional or unintentional contamination.

In one embodiment, the disclosed apparatus and process effectively removes the one or more contaminants from a fluid containing particularly high concentrations of contaminants. The disclosed apparatus and process are effective in decreasing the contaminants to levels safe for human and/or other living organism exposure to the fluid (such as, for consumption and/or inhalation). For example, the apparatus can substantially decrease the level of one or more contaminants in the fluid to at least about 100 ppm, preferably to at least about 10 ppm. In some embodiments, the apparatus can substantially decrease the level of the one or more contaminants to no more than about 1 ppm.

In a preferred embodiment, the apparatus can substantially decrease the level of the one or more contaminants to no more than about 100 ppb, more preferred to an amount of less than about 20 ppb. In an even more preferred embodiment, the decreased level of one or more contaminants contained within the fluid is less than about 10 ppb, in others less than about 5 ppb and in still others less than about 2 ppb. It can be appreciated, the level to which the one or more contaminants are decreased in the fluid can depend on one or more of: i) the initial contaminant level in the fluid, ii) the contaminant (as for example, without limitation, the chemical and/or physical properties of the contaminant); iii) the conditions under which the contaminant and apparatus are contacted (as for example, without limitation, one or more of contacting temperature and/or length of contacting time); iv) the apparatus physical properties (such as, without limitation, the apparatus size, permeability, and/or pore structure); and v) combinations thereof.

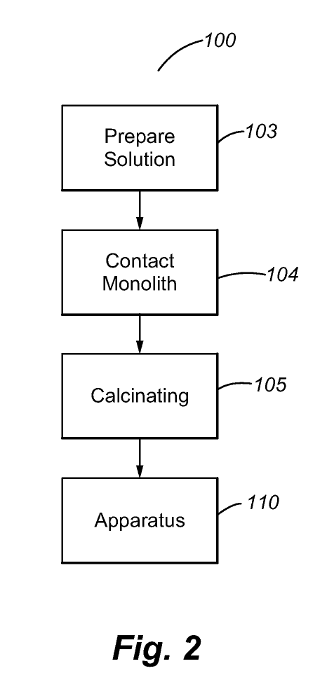

FIG. 2 depicts a process 100 for making an apparatus 110. The apparatus 110 comprises a monolith. Preferably, the monolith comprises a continuous phase filtering element having opposing fluid ingress and egress surface. The monolith has a void volume and a plurality of pores. The apparatus 110 further comprises an insoluble rare earth composition contained within the pores and/or void volume of the monolith. Preferably, the insoluble rare earth composition can comprise a film and/or a plurality of particles. The rare earth film and/or plurality of particles are substantially positioned within the pores and/or void volume of the monolith

In step 103, a rare earth-containing solution is prepared. In one embodiment, the rare earth-containing solution can be prepared by dissolving and/or dispersing a rare earth metal and/or rare earth-containing material in a solution to form a pregnant rare earth-containing solution. In a preferred embodiment, the rare earth-containing solution is prepared by dissolving the rare earth metal and/or rare earth-containing material in an acidic solution. The acidic solution may preferably comprises a mineral acid, such as, but not limited to hydrochloric acid (HCl), nitric acid (HNO₃), iodic acid (HIO₃), chloric acid (HClO₃), bromic acid (HBrO₃), hydrobromic acid (HBr), hydrofluoric acid (HF), sulfuric acid (H₂SO₄), phosphoric acid (H₃PO₄), and a mixture thereof. In another embodiment, a rare earth-containing material is dissolved in a solvent, such as water, to from the pregnant rare earth-containing solution. Preferably, the pregnant rare earth-containing solution comprises the rare earth material in a substantially dissolved state. In some instances, the pregnant rare earth-containing solution comprises a suspension and/or dispersion of the rare earth material.

In a preferred embodiment, the rare earth solution comprises a rare earth comprising one of a rare earth carbonate, nitrate, iodate, sulfate, chlorate, bromate, acetate, formate, or oxalate. In a more preferred embodiment, the rare earth solution comprises at least one of cerium carbonate, cerium nitrate, cerium iodate, cerium sulfate, cerium chlorate, cerium bromate, cerium acetate, cerium formate and cerium oxalate.

In a preferred embodiment, the total rare earth content of the pregnant rare earth-containing solution is at least about 0.1% by mass of the total pregnant rare earth-containing solution as measured as a rare earth oxide. In a more preferred embodiment, the total rare earth content of the pregnant rare earth-containing solution is at least about 1% by mass of the total pregnant solution. In an even more preferred embodiment, the rare earth content of the pregnant solution comprises about 5% of the total mass of the pregnant rare earth-containing solution, as measured as a rare earth oxide.

Preferably, the rare earth content of the pregnant solution is from about 10% to about 90% by mass of the pregnant rare earth-containing solution as measured as a rare earth oxide, such as CeO₂. More preferably, the total rare earth content of the pregnant rare earth-containing solution is from about 20% to about 75% by mass as measured as rare earth oxide. Even more preferably, the total rare earth content of the pregnant rare earth-containing solution is from about 25% to about 45% by mass as measured as rare earth oxide. In a still yet even more preferred embodiment, the total rare earth content of the pregnant rare earth-containing solution is from about 35% to about 40% by mass as measured as rare earth oxide. In yet even more preferred embodiment, the total rare earth content of the pregnant rare earth-containing solution is about 40% by mass as measured rare earth oxide, such as, but not limited to CeO₂.

It can be appreciated that the concentration of the pregnant rare earth-containing solution is sufficiently concentrated enough to substantially coat at least some of the pores and pore volume of the monolith. Moreover on the other hand, the concentration of the pregnant rare earth-containing solution is sufficiently dilute so that the coating formed does not substantially diminish the permeability of the coated monolith.

In the contacting step 104 the monolith is contacted with the pregnant rare earth-containing solution to form a wet-coated, impregnated monolith. In one embodiment the monolith is submerged into the pregnant rare earth-containing solution, the submersion can be with or without agitation. The immersion time can be from about 0.1 hour to about 48, preferably from about 1 hour to about 24 hours.

Optionally, one or both of heat and pressure are applied during or before contacting of the support with the pregnant rare earth-containing solution. Preferably, at least the heat is applied to the pregnant rare earth-containing solution before and/or during the contacting step. The application of heat to the pregnant rare earth-containing solution can substantially decrease the one or both of the surface tension and viscosity of the pregnant rare earth-containing solution. The decreased surface tension and/or viscosity substantially can allow for better impregnating and/or wetting of the pregnant rare earth-containing solution of the monolith. Furthermore, the application of pressure can allow for better impregnating and/or wetting of the pregnant rare earth-containing solution of the monolith. For example, the pressure can be a positive pressure applied to the pregnant solution during contacting of the monolith with the pregnant rare earth-containing solution and/or the pressure can be a negative pressure applied to the monolith prior to the contacting of the monolith with the pregnant rare earth-containing solution.

In one embodiment, the rare earth-containing solution can contain one or more flow additives, such as, but not limited to surfactants, wetting agents and viscosity modifiers. The one or more flow additives can be added to the pregnant rare earth-containing solution prior to or during the submersion process. The one or more additives can assist the rare earth-containing solution to impregnate the monolith and wet the pores and/or void volume of the monolith.

In yet another embodiment, the contacting of pregnant rare earth-containing solution with the monolith is by spray coating, curtain coating, dipping (completely or partially), kiss-coating, and coating under greater than atmospheric pressures. It can be appreciated, that, other coating methods well know within the art are likewise suitable.

The monolith is preferably a single support structure which can function as a filtering and/or separating element. In a preferred embodiment, the monolith comprises a permeable material. The permeable material can be a solid, cylinder, sheet-like, and/or tubular material.

The monolith has one or more exterior surfaces, plurality of pores, a void volume, a total bulk volume, porosity, and permeability. The void volume comprises the volume occupied by the plurality of pores contained within the monolith, while the total bulk volume is the volume of the monolith. In other words, the void volume is the volume of pore (that is, void) space contained within the total bulk volume of the monolith. The ratio of the void volume to total bulk volume is the porosity of the monolith. The porosity of the monolith is the fraction of the monolith volume capable of being occupied by a fluid. The void volume comprises one or both of interconnected and non-interconnected void volumes (that is, interconnected and non-interconnected pores).

The interconnected pores have a total interconnected pore surface area. In one embodiment, the total interconnected pore surface area of the monolith is at least about 0.5 m² per gram of the uncoated monolith (herein expressed as m²/g). In a preferred embodiment, the total interconnected pore surface area of the monolith is at least about 1 m²/g. In a more preferred embodiment, the total interconnected pore surface area of the monolith is at least about 5 m²/g. The interconnected pore surface area can be in some embodiments as large as at least 10 m²/g and in still other embodiments as large as at least about 50 m²/g.

The permeability of the monolith is a measure of the ease, with which a fluid will flow through the interconnected void volumes (that is, interconnected pores). A high porosity monolith having substantially most, if not all, of the void volumes interconnected will have a substantially higher permeability than another monolith having the same porosity but substantially most, if not all, of the void volumes non-interconnected.

The plurality of pores comprising the porosity and permeability of the monolith has an average pore size. Preferably, the average pore size is from about 0.05 μm to about 1.0 μm. More preferably, the average pore size is from about 0.1 μm to about 0.5 μm. Furthermore, the monolith has an effective pore size. The effective pore size is a measure of the average smallest particle retained within the volume. The small particles may be retained and entrapped within the void volume by one or more of dispersion forces (such as, London's or Van der Waals forces) or by retention within a labyrinth of tortuously interconnect void volumes. The effective pore size is much smaller than the average pore size measured by porometry. In one embodiment, at least about 95% of the monolith's pores are greater than about 0.05 micron. In preferred embodiment, at least about 95% of the monolith's pores are greater than about 0.1 micron.

In one embodiment, the monolith comprises a ceramic material. The ceramic material may be one of an inorganic crystalline oxide material, inorganic non-crystalline oxide material or a combination thereof. Non-limiting examples of inorganic crystalline oxide materials are ceramics comprising one or more of quartz, feldspar, kaolin clay, china clay, clay, alumina, silica, mullite, silicate, kaolinite, ball clay, bone ash, steatite, petuntse, alabaster, zirconia, carbide, boride, silicide and combinations thereof. Non-limiting examples of inorganic non-crystalline oxide materials are ceramics comprising one or more of quartz, feldspar, kaolin clay, china clay, clay, alumina, silica, mullite, silicate, kaolinite, ball clay, bone ash, steatite, petuntse, alabaster, zirconia, carbide, boride, silicide and combinations thereof having at least some, if not mostly, amorphous character. Preferably, the monolith comprises one of a silica, alumina, zirconia, carbide and/or boride ceramic material. More preferably, the monolith comprises one of a silica and/or alumina ceramic material.

The wet-coated impregnated monolith comprises rare earth-containing solution contained within one or both of at least some the pores and void volume of the monolith. Preferably, the wet-coated impregnated monolith comprises the rare earth-containing solution contained within most, if not all, of the pores and void volume of the monolith. When the pregnant rare earth-containing solution comprises a suspension and/or dispersion of the rare earth material, the exterior pores and the exterior void volume of the monolith are substantially impregnated with the suspended and/or dispersed rare earth material. The wet-coated impregnated monolith is formed by the pregnant rare earth-containing solution one or both impregnates and/or wets at least some, if not most or all, of the interconnected pores of the monolith.

In step 105, the impregnated monolith is calcined to form the apparatus 110.

Optionally, a drying step (not depicted in process 100) can be included prior to calcining step 103. The drying step can be conducted at or above ambient temperature. The drying period of time can be less than a minute or more than about a week. Preferably, the drying time is from about 10 minutes to about 24 hours. More preferably, the drying time is from about 30 minutes to about 12 hours, even more preferably form about 1 hour to about 8 hours. In another configuration, the period of time thermal energy is applied is from about 3 hours to about 6 hours. When the optional drying step is at a temperature greater than ambient the temperature, the drying temperature is from about 20 degrees Celsius to about 200 degrees Celsius, preferably from about 80 degrees Celsius to about 100 degrees Celsius. The drying step substantially removes most, if not all, of the solution liquid phase to form a dried rare earth material film on the pore and/or void volume surfaces of the monolith.

The calcining step 103 comprises heating in a furnace the impregnated monolith and/or the monolith having a dried rare earth material film. Preferably, the calcining step 103 further comprises heating in the presence of air and/or oxygen. The monolith is heated in the furnace to a temperature of from about 250 degrees Celsius to about 900 degrees Celsius, preferably from a temperature of about 300 degrees Celsius to about 700 degrees Celsius.

In the situation where the rare earth composition comprises cerium, the temperature and pressure conditions of the calcining step 103 may be altered depending on the composition of the cerium-containing starting materials and the desired physical properties of the insoluble cerium-containing compound. In embodiments where the insoluble rare earth-containing compound comprises a cerium oxide, the insoluble rare earth-containing compound can include a cerium oxide such as CeO₂. The reactions for cerium carbonate, cerium nitrate, cerium sulfate, cerium iodate, cerium chlorate, curium bormate, and cerium oxalate may be summarized as:

Ce₂(CO₃)₃+½O₂→2CeO₂+3CO₂ (2)

½Ce(NO₃)₃+ 3/2O₂→½CeO₂+3NO₂ (3)

Ce₂(C₂O₄)₃+2O₂→2CeO₂+6CO₂ (4)

½Ce(SO₄)₃+½O₂→½CeO₂+3SO₂ (5)

Ce(XO₃)₃→CeO₂+3X₂+ 7/2O₂ (6)

where X is one of F, Cl, Br, and I.

The calcining produces insoluble rare earth oxide film and/or particles within the one or both of the monolith pores and void volume, preferably the insoluble rare earth oxide film and/or particles are substantially within at least most of the interconnected pores. The insoluble rare earth particles within the pores and/or void volume of the monolith are sufficiently small so as not to substantially impair the permeability of the monolith. Preferably, the permeability of the monolith after the calcining step is substantially at least about 50% or more of the permeability of monolith prior to contacting the monolith with the rare earth-containing solution. More preferably, the permeability of the monolith after the calcining step is substantially about at least 75% or more of the permeability of monolith prior to contacting the monolith with the rare earth-containing solution. Even more preferably, the permeability of the monolith after the calcining step is substantially about at least 90% or more of the permeability of monolith prior to contacting the monolith with the rare earth-containing solution.

The insoluble rare earth composition forms an insoluble rare film within the interconnected pores. The insoluble rare earth film has an average film thickness. Preferably, the average film thickness is from about 0.5 nm to about 500 nm. More preferably, the insoluble rare earth composition average film thickness is from about 2 nm to about 50 nm. Even more preferably, the average film thickness of the insoluble rare earth composition is from about 3 nm to about 20 nm.

Stated another way, at least some, if not most or all, of the interconnected pores comprising the apparatus 110 have an average film thickness of the insoluble rare earth composition from about 0.5 nm to about 500 nm. In a more preferred embodiment, the average film thickness of the insoluble rare earth composition is from about 2 nm to about 50 nm. In an even more preferred embodiment, the average film thickness of the insoluble rare earth composition coating for at least some, if not most or all, of the interconnected pores is from about 3 nm to about 20 nm.

The insoluble rare earth film contained within interconnected pores has a total insoluble rare earth film surface area. In one embodiment, the total insoluble rare earth film surface area of the apparatus is at least about 0.5 m² per gram of the uncoated monolith (or, at least about 25 m² for 50 gram uncoated monolith). In a preferred embodiment, the total insoluble rare earth film surface area of the apparatus is at least about 1 m² per gram of the uncoated monolith (or, at least about 50 m² for 50 gram uncoated monolith). In a more preferred embodiment, the total insoluble rare earth film surface area for the apparatus is at least about 5 m² per gram of the uncoated monolith (or, at least about 250 m² for 50 gram uncoated monolith). The total insoluble rare earth film surface area can be in some embodiments as large as at least 10 m² and in still other embodiments as large as at least about 50 m² per gram of the uncoated monolith (or, respectively, at least about 500 m² or 2,500 m² for 50 gram uncoated monolith).

Furthermore, the insoluble rare earth composition comprises particles having an average surface area of at least about 1 m²/g. Depending upon the application, higher average surface areas may be desired. Specifically, the insoluble rare earth particulates may have a surface area of at least about 5 m²/g, in other cases more than about 10 m²/g, in other cases more than about 70 m²/g, in other cases more than about 85 m²/g, in still other cases more than 115 m²/g, and in yet other cases more than about 160 m²/g. In addition, it is envisioned that the insoluble rare earth particulates with higher surface areas will be more effective. One skilled in the art will recognize that the surface area of the insoluble rare earth particle will impact the fluid dynamic properties within the rare earth containing monolith. As a result, there may be a need to balance benefits derived from increased particle surface areas with fluid dynamics, such as any pressure drop that may occur.

In another preferred embodiment, the apparatus 110 has a flow rate of more than about 0.5 L/min at about 40 psi. In a more preferred embodiment, the flow rate of the apparatus 110 is more than about 1 L/min at about 40 psi. In other configurations, the apparatus 110 has a flow rate of more than about 5 L/min at about 40 psi.

In yet another preferred embodiment, the apparatus 110 has a permeability from about 10 Lmh/psi to about 500 Lmh/psi. In a more preferred embodiment, the permeability of the apparatus 110 is from about 50 Lmh/psi to about 200 Lmh/psi. In an even more preferred embodiment, the apparatus 110 has a permeability from about 100 Lmh/psi to about 150 Lmh/psi.

In a preferred embodiment, one or both of the internal and external surfaces of the monolith are sufficiently coated with the insoluble rare earth-containing film and/or particles to remove substantially one or more contaminants from a contaminant-containing fluid stream. Furthermore, the coated monolith substantially maintains a sufficient fluid flow through the coated monolith. That is, the rare earth-containing monolith provides for one or more of: fluid flow rate through the coated monolith, little, if any, pressure drop, and substantially effective removal of one or more contaminants from the contaminant-containing fluid stream. It can be appreciated fluid flow rate and pressure drop vary depending on the fluid. For example, liquid fluids are typically more resistant to fluid flow than gaseous fluids.

Coating the interconnected pores of the monolith with the insoluble rare earth composition provides a substantially large, reactive, insoluble rare composition surface area on and/or within the apparatus 110. Furthermore, the insoluble rare earth film average film thickness is small enough to substantially maintain the permeability of the apparatus and, therefore, the apparatus has one or both of the minimal pressure drop and high flow rate when in contact with a fluid. The apparatus 110 is substantially less susceptible to fluid channeling than a filter bed comprising insoluble rare earth-containing particle beds. Moreover, the apparatus 110 is not susceptible to bed separation as is a filter bed.

The apparatus 110 provides for one or more substantially larger insoluble rare composition surface areas per gram of rare earth and/or substantially more efficient and/or effective contacting of a fluid stream with the insoluble rare earth composition. While not wanting to be limited by theory, the contacting of the fluid stream within the insoluble rare earth film within the interconnected pores of the monolith is believed to be a more efficient and effective contacting of the fluid and the insoluble rare earth composition than within a bed volume comprising rare earth-containing particles.

After the calcining step 103, the apparatus 110 may be acid treated and washed to remove remaining carbonate, nitrate, and/or oxalate. Thermal decomposition processes for producing cerium oxides having various features are described in U.S. Pat. No. 5,897,675 (specific surface areas), U.S. Pat. No. 5,994,260 (pores with uniform lamellar structure), U.S. Pat. No. 6,706,082 (specific particle size distribution), and U.S. Pat. No. 6,887,566 (spherical particles), and such descriptions are incorporated herein by reference. Cerium compounds containing carbonate, nitrate and/or oxalate are commercially available and may be obtained from any source known to those skilled in the art. Furthermore, the cerium nitrate may be prepared, such as, by dissolving cerium metal or an appropriate cerium salt (such as cerium carbonate) in nitric acid to form Ce(NO₃)₃.

In another embodiment, the rare earth-containing porous monolithic ceramic filter comprises materials that are chemically and/or physically durable. Chemical and/or physical durability means the monolithic ceramic filter does not substantially degrade and/or decompose during a period of operation. Preferably, the period of operation without substantial degradation and/or decomposition is at least about 2 years, more preferably at least about 5 years and even more preferably at least about 10 years. Even more, preferably the monolithic ceramic filter does not substantially degrade and/or decompose for a period of operation of at least about 20 years.

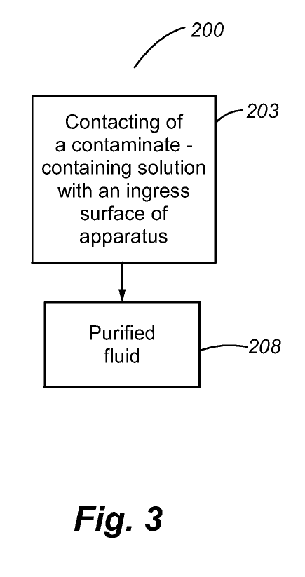

FIG. 3 depicts a process 200 for using the apparatus 110 to remove one or more contaminants contained within a contaminant-containing fluid stream.

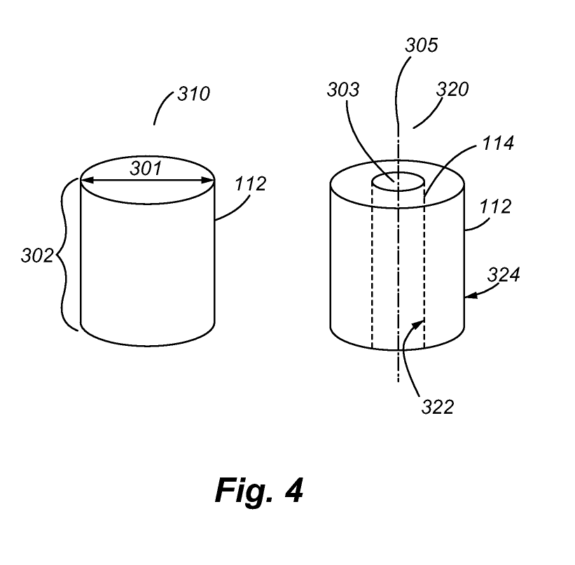

In step 203, the contaminant-containing fluid stream is contacted with an ingress surface 112 of apparatus 110. FIG. 4 depicts non-limiting examples of suitable geometric shapes of the apparatus 110 having opposing ingress 112 and egress 114 surfaces. The apparatus 110 can be of any suitable size and/or shape. In a preferred embodiment, the apparatus 110 has a shape of cylinder 310 having a diameter 301 and a height 302. In another embodiment, cylinder 320 has a void 303 positioned along the axis 305 of the cylinder and opposing internal 322 and external 324 surfaces. As can be appreciated, the ingress 112 and egress 114 surfaces of the apparatus 110 can be interchangeable. For example, in configuration the external surface 324 can be the ingress surface 112 and the internal surface 322 can be the egress surface 114; and in another configuration the ingress surface 112 can be the internal surface 322 and the egress surface 114 can be the external surface 324.

The contaminant-containing fluid stream is contacted with the apparatus 110 at sufficient pressure for the contaminant-containing fluid to flow through the apparatus 110 from the ingress surface 112 to egress surface 114, a purified fluid 208 exists at the egress surface 114. The purified fluid 208 contains substantially less of at least one of the one or more contaminants contained with contaminant-containing fluid. In a preferred embodiment, at least some, if not most, of the one or more contaminants are removed from the contaminant-containing fluid to substantially make the fluid suitable for use by a human being and/or other living organism. It can be appreciated, the contaminant removal level for each of the one or more contaminants contained within the contaminant-containing stream depends on the one or more contaminant and concentration each of the one or more contaminants contained within the contaminant-containing stream. While not wanting to be bound by any example, for most of the chemical warfare agents, at least most, if not all, of the chemical warfare agent contaminant is removed to make the purified stream substantially safe for a human being and/or other living organism.

The porosity and permeability can affect the contacting pressure needed to achieve flow fluid through the apparatus 110. The contaminant-containing fluid can flow through the apparatus 110 under the influence of gravity, pressure or other means and with or without agitation or mixing. While not wanting to be limited by any theory, the contacting pressure for the contaminant-containing fluid to flow through apparatus 110 decreases the greater one or both of porosity and permeability of the apparatus 110.

The contaminant-containing fluid is in contact with the apparatus 110 for a period of time. Preferably, the contact time can be as little as 10 seconds. In another embodiment, the contact time can be about 1 to about 20 minutes. In yet another embodiment, the contact time can be from about 0.5 hours to about 12 hours. The contact time can vary depending on one or more of the geometry and size of the apparatus 110, the porosity and/or permeability of the apparatus 110, the contacting pressure, the fluid properties (such as viscosity, surface tension) and the contaminant and contaminant concentration within the contaminant-containing fluid. The disclosed apparatus 110 and process 200 can effectively remove one or more contaminants from the contaminant-containing fluid. When the contaminant-containing fluid comprises a liquid fluid the apparatus 110 can remove the one or more contaminants over a wide range of pH levels, as well as at extreme pH values. In contrast to many conventional contaminant removal techniques, this capability eliminates the need to alter and/or maintain the pH of the liquid fluid within a narrow range when removing the one or more contaminants. Further, elimination of the need to adjust and maintain pH while removing the one or more contaminants from the contaminant-containing fluid provides significant cost advantages.

Although the apparatus 110 is capable of removing the one or more contaminants from the contaminant-containing fluid at ambient temperatures, it has been found that the capacity of the apparatus 110 having insoluble rare earth-containing materials to remove and/or adsorb the one or more contaminants from the contaminant-containing solution can be increased by increasing the temperature of the apparatus 110. In one embodiment, one or both of the contaminant-containing fluid and the apparatus 110 are heated prior to and/or during the contacting step 203. The contaminated-containing fluid and/or apparatus 110 can be heated by any heating process well known within the art. It has been found that heat can increase one or both of rate of contaminant removal and amount of contaminants removed from the contaminant-containing fluid. As a result, a container housing the apparatus 110 can be provided with a heating jacket or other heating method for maintaining the container and the apparatus 110 at a desired temperature.

Another aspect of the present invention provides a system for removing one or more contaminants from a contaminant-containing fluid. The system comprises a container that includes a housing having a first end and a second end opposite the first end and an inlet and an outlet. An outer wall extends between the first and second ends enclosing a fluid flow path between the inlet and the outlet. The apparatus 110 is disposed within the housing in the fluid flow path for treating a flow of the contaminant-containing fluid through the container. The inlet is operably interconnected to the ingress surface 112 and the outlet is operably connected to the egress surface. In one embodiment, the apparatus 110 is spaced apart from one or more of the inlet, the outlet and the outer wall to define one or more spaces between the apparatus 110 and the inlet, between the apparatus 110 and the outlet, and between the apparatus 110 and the outer wall.

In another embodiment, the container can further comprise a fluid permeable outer wall and/or a pre-filter adjacent to the inlet and before the apparatus 110. Particulates are removed from the contaminant-containing fluid by the fluid permeable outer wall and/or pre-filter. Various fittings, connections, pumps, valves, manifolds and the like can be used to control the fluid flow through one or both of the apparatus 110 and container.

In another embodiment, the container can further comprise a post-treatment system for further polishing of the purified fluid 208. The post-treatment system can comprise one or more of a rare-earth composition and fixing agent as discussed in U.S. Pat. No. 6,863,825 and U.S. patent application Ser. Nos. 12/616,653 with filing date of Nov. 11, 2009; 11/932,837, 11/931,616, 11/932,702 and 11/931,543 each with a filing date of Oct. 31, 2007; and 11/958,644, 11/958,968 and 11/958,602 each with a filing date of Dec. 18, 2007, each of which is incorporated herein in its entirety by this reference. The polishing of the purified fluid 208 can further remove toxins and/or other species contained within the purified fluid 208 as discussed in the above referenced patent and/or patent applications. Optional post-treatment systems may include transition metals and alkaline metals as described in U.S. Pat. No. 5,922,926, polyoxometallates as described in U.S. Patent Application Publication No. 2005/0159307 A1, aluminum oxides as described in U.S. Pat. Nos. 5,689,038 and 6,852903, quaternary ammonium complexes as described in U.S. Pat. No. 5,859,064, zeolites as described in U.S. Pat. No. 6,537,382, and enzymes as described in U.S. Pat. No. 7,067,294. The descriptions of these decontamination agents in the noted references are incorporated herein by reference.

The container can take a variety of forms including columns, various tanks and reactors, filters, filter beds, drums, cartridges, fluid permeable containers and the like. In some embodiments, the container will include one or more apparatuses 110 configured in series, parallel and any combination thereof within which the contaminant-containing fluid will contact each of the one or more apparatuses 110. The container can have a single pass through design with a designated fluid inlet and fluid outlet. Where a more rigid container structure is preferred, the container can be manufactured from metals, plastics such as PVC or acrylic, or other insoluble materials that will maintain a desired shape under conditions of use.

The system may also optionally include one or more of a visual indicator for indicating when the apparatus 110 should be replaced or regenerated, a sensor for sensing an effluent flowing out of the container, and method for sterilizing and/or regenerating the apparatus 110. The container can be adapted to be inserted into and removed from a processing system or process stream to facilitate use and replacement of the apparatus 110. The container inlet and outlet can be adapted to be sealed when removed from the processing system or process stream or when otherwise not in use to enable the safe handling, transport and storage of the container and the apparatus 110.

Methods for sterilizing the apparatus 110 can include one or more of heating the apparatus 110, irradiating the apparatus 110 and introducing a chemical oxidation agent into the fluid flow path, such as are known in the art. Where the apparatus 110 is to be periodically sterilized, the apparatus 110 and container may be removed from the processing system and sterilized as a unit, without the need to remove the apparatus 110 from the container.

In one embodiment, after the apparatus 110 has been exposed to a flow of contaminant-containing fluid, the process further includes introducing a sealant into the one or more spaces between the apparatus 110 and the inlet, between the apparatus 110 and the outlet, and between the apparatus 110 and the outer wall to seat the housing for disposal. The sealant can comprise any material that substantially permanently seals the container. Preferred sealants comprise thermosetting polymeric materials. In addition, the container may also be constructed to provide long term storage or to serve as a disposal unit for the contaminants removed from the contaminant-containing fluid.

In another embodiment, the apparatus 110 can be regenerated after removing one or more contaminants from the contaminated-containing fluid. In one application, a regenerating solution is an alkaline and comprises a strong base. The strong base can comprise an alkali metal hydroxide and group I salt of ammonia, amides, and primary, secondary, tertiary, or quaternary amines, with alkali metal hydroxides being more preferred, and alkali metal hydroxides being even more preferred. While not wishing to be bound by any theory, it is believed that, at high concentrations, hydroxide ions compete with, and displace, at least some, if not most, of the contaminants adsorbed on the insoluble rare earth composition. In one embodiment, the regenerating solution includes a caustic compound in an amount preferably ranging from about 1 to about 15 wt %, even more preferably from about 1 to about 10 wt %, and even more preferably from about 2.5 to about 7.5 wt %, with about 5 wt % being even more preferred.

The preferred pH of the regenerating solution is preferably greater (e.g., more basic) than the pH at which the one or more contaminant was adsorbed onto the insoluble rare earth composition. The regenerating solution pH is preferably at least about pH 10, even more preferably at least about pH 12, and even more preferably at least about pH 14.

In another application, a first regenerating solution comprises an oxalate or ethanedioate, which, relative to adsorbed one or more contaminants, is preferentially sorbed, over a broad pH range, by the insoluble rare earth composition. In one process variation to desorb oxalate ions, the insoluble rare earth composition is contacted with a second regenerating solution having a preferred pH of at least about pH 9 and even more preferably of at least about pH 11 to desorb oxalate and/or ethanedioate ions in favor of hydroxide ions. A strong base is preferred for the second regenerating solution. Alternatively, the sorbed oxalate and/or ethanedioate anions can be heated to a preferred temperature of at least about 500 degrees Celsius to thermally decompose the sorbed oxalate and/or ethanedioate ions and remove them from the insoluble rare earth composition.

In another application, a first regenerating solution includes a strongly adsorbing exchange oxyanion, such as phosphate, carbonate, silicate, vanadium oxide, or fluoride, to displace the sorbed contaminant. The first regenerating solution has a relatively high concentration of the exchange oxyanion or fluoride. Desorption of the exchange oxyanion or fluoride is at done at a different (higher) pH and/or exchange oxyanion concentration than the first regenerating solution. For example, desorption can be by a second regenerating solution which includes a strong base and has a lower concentration of the exchange oxyanion than the oxyanion concentration in the first regenerating solution. Alternatively, the exchange oxyanion can be thermally decomposed to regenerate the insoluble rare earth composition. Alternatively, the exchange oxyanion can be desorbed by oxidation or reduction of the insoluble rare earth composition or exchange oxyanion.

In another application, the regenerating solution includes a reductant or reducing agent, such as ferrous ion, lithium aluminum hydride, nascent hydrogen, sodium amalgam, sodium borohydride, stannous ion, sulfite compounds, hydrazine (Wolff-Kishner reduction), zinc-mercury amalgam, diisobutylaluminum hydride, lindlar catalyst, oxalic acid, formic acid, and a carboxylic acid (e.g., a sugar acid, such as ascorbic acid), to reduce the rare earth, sorbed target material, and/or sorbed target material-containing oxyanion. While not wishing to be bound by any theory nor by way of example, surface reduction of the insoluble rare earth composition will reduce cerium (IV) to cerium (III), which may interact less strongly with target materials and oxyanions. Following or concurrently with surface reduction of the insoluble rare earth composition, the pH is increased to desorb the one or more contaminants.

In another application, the regenerating solution includes an oxidant or oxidizing agent, e.g., peroxygen compounds (e.g., peroxide, permanganate, persulfate, etc.), ozone, chlorine, hypochlorite, Fenton's reagent, molecular oxygen, phosphate, sulfur dioxide, and the like, that oxidizes the sorbed the one or more contaminants, followed by a pH adjustment and a desorption process. Desorption of the one or more contaminants from the insoluble rare earth composition, for example, typically occurs at a pH of at least about pH 12 and even more typically at least about pH 14.

Another aspect of the present invention is membrane containing one or more insoluble rare earth-containing compositions. The membrane can be any hollow fiber membrane. Examples of such membranes are reverse osmosis membranes, ultra-filtration membranes, and such. The insoluble rare earth-containing membranes can be prepared by impregnating the membrane with a soluble rare earth-containing composition as described above for the monolith. In one configuration, at least a partial vacuum can be applied to the membrane and the pregnant rare earth containing solution (as described above) can be “sucked” into the membrane under the reduced pressure. The rare earth-containing membrane is then treated with to one or more: 1) precipitate the rare earth to form an insoluble rare earth and 2) further reacting the impregnated rare earth to form a rare earth oxide, such as, CeO₂. A non-limiting example of precipitating the impregnated rare to form an insoluble rare earth is treating the impregnated rare earth membrane with hydroxide to form a rare earth precipitate within the membrane. A non-limiting example of further reacting the impregnated membrane is reacting impregnated membrane with a strong oxidant to convert the impregnated rare earth composition to rare earth oxide.

### Example I

Four filters each containing 25 grams of ceria-coated alumina were challenged with 30 liters of NSF P231 “general test water 2” at a pH of about 9, containing 20 mg/L tannic acid. The ceria-coated alumina pre-filters decreased the oxidant demand of the water from about 41 ppm (NaOCl) to an average of 12 ppm (NaOCl). The oxidant demand of the water treated with the ceria-coated pre-filters decreased by about 75%. This decreased demand translates to a decrease in the amount of halogenated resin necessary to produce a 4 Log₁₀ virus removal. FIG. 4 is a graphical representation of the retention of humic acid on 20 g of ceria-coated alumina challenged by 6 mg/L and a 10 min contact time.

### Example II

Ceria absorbent media was shown to be effective for removing large amounts of natural organic matter, such as humic and/or tannic acids. The organic material was removed at fast water flow rates and small contact times of less than about 30 seconds over a large range of pH values. The organic matter was removed from an aqueous solution with ceria oxide powders having surface areas of about 50 m²/g or greater, about 100 m²/g or greater, and about 130 m²/g or greater. Furthermore, the organic matter was removed from an aqueous stream with cerium oxide-coated alumina having a surface area of about 200 m²/g or greater. Moreover, cerium oxide coated onto other support media or agglomerated cerium oxide powder having a surface area of about 75 m²/g or greater removed humic and/or tannic acids from the aqueous stream. In each instance, the cerium containing material effectively removed the organic matter from the aqueous stream to produce a clear colorless solution.

However, the organic matter substantially remained in the organic matter-containing water when the organic matter-containing water was treated with either a hollow fiber microfilter followed by activate carbon packed bed media or with a hollow fiber microfilter. In both of these instances, the treated water was one or both of hazy and colored, indicating the presence of organic matter within the water. The hollow fiber microfilter had a pore sixe of about 0.2 μm.

### Example III

A 55 gram diatomite filter was loaded with 11 grams of CeO₂, by impregnating the filter with a cerium nitrate aqueous solution and calcining the impregnated filter to form CeO₂. The diatomite filter was impregnated with the cerium nitrate solution from about an hour to about 24 hours to substantially saturate the filter with the cerium nitrate solution. The impregnated filter was dried under warm conditions to evaporate the water from the cerium nitrate impregnated filters. The dried filters were calcinated under two different conditions.

One set of dried filters were calcinated in an oxidizing atmosphere for 1 hour at about 500 degrees Celsius. The filters were loaded with about 18 grams of CeO₂, the CeO₂ accounted for about 30% of mass of the coated filter. The filters had a flow rate of about 600 ml/minute at 50 psi, which was about a 30% reduction in the flow rate compared to the un-coated filters. The initial vial contaminant challenge showed 100% efficacy for viral contaminant removal. The contaminant removal capacity of the filters failed after treating about 50 liters of contaminant-containing water. The shortened treatment capacity is believed to be due to incomplete conversion of cerium nitrate to cerium oxide.

The other set of dried filters were calcinated for 2 hours at 700 degrees Celsius. The filters were loaded with about 18 grams of CeO₂. The flow rate of the filters was about 800 ml/minute at about 50 psi. One of CeO₂ loaded filters had a viral removal efficiency of about 100% for about 160 liters of viral contaminant-containing solution. Another of the CeO₂ loaded filters was challenged with a contaminant-containing water having both virus and bacteria, the filter showed contaminant breakthrough after treating about 60 liters of the contaminant-containing water.

The mercury porosimetry of the un-coated filter indicated the filter had a 6 m²/g of pore area, that is, the filter have about 3,000,000 cm² available for coating. Based on the mass and density of CeO₂ loaded on the filter, the average CeO₂ coating thickness on the filter is about 0.005 microns. The mercury porosimetry of the filter indicated that most (that is about 95%) of the filter's pores are at least about 0.1 micron. Given the CeO₂ average coating thickness and the given pore size of the filter, the coated pores are expected to have minimum diameter of about 0.09 micron. Furthermore, the data indicate that the CeO₂ loading can be at least doubled to include about 40-50% of the total mass of the loaded filter and have at least most of the with a diameter of about 0.08 microns.

### Example IV

400 ml of 140 mg/L solution of humic acid (over five times the NSF P248 requirement) was passed through a column containing a volume of about 12.3 cm³ of cerium oxide. The column effluent possessed no visible color and a spectrophotometer analysis of the effluent indicated a humic acid removal capacity of about 93%. A batch analysis experiment indicated a humic acid removal capacity of about 175 mg humic acid per cubic inch of cerium oxide bed depth.

A number of variations and modifications of the invention can be used. It would be possible to provide for some features of the invention without providing others.

While the various processes are discussed with reference to liquids, it is to be appreciated that the processes can be applies to other fluids, such as gases. Examples of arsenic-containing gases include smelter and roaster off-gases and utility flue gas.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An apparatus, comprising:
a permeable monolith having a plurality of interconnected pores, an ingress surface, and an egress surface, the ingress and egress surfaces being in fluid communication, via the interconnected pores, to permit a contaminant-containing fluid to flow through the interconnected pores for discharge through the egress surface; and
an insoluble rare earth composition within the interconnected pores to remove the contaminant from the contaminant-containing fluid.

2. The apparatus of claim 1, wherein the insoluble rare earth is in the form of at least one of a film and a plurality of particles.

3. The apparatus of claim 1, wherein the insoluble rare earth comprises a film and wherein the film has a thickness from about 2 nm to about 50 nm.

4. The apparatus of claim 1, wherein the insoluble rare earth comprises a film having a film surface area of at least about 5 m² per gram of the monolith.

5. The apparatus of claim 1, wherein the insoluble earth composition comprises particles having an average surface area of more than about 115 m²/g.

6. The apparatus of claim 1, wherein the insoluble rare earth composition comprises cerium.

7. The apparatus of claim 1, wherein the insoluble rare earth composition comprises at least one of cerium (IV) oxide (CeO₂) and cerium (III) oxide (Ce₂O₃).

8. The apparatus of claim 1, wherein the insoluble rare earth composition comprises from about 1 wt % to about 65 wt % of the apparatus.

9. The apparatus of claim 1, wherein the insoluble rare earth composition comprises one or more of lanthanum, cerium, praseodymium, neodymium, promethium, samarium, europium, gadolinium, terbium, dysprosium, holmium erbium, thulium, ytterbium and lutetium.

10. The apparatus of claim 1, wherein the monolith comprises a ceramic material.

11. The apparatus of claim 10, wherein the ceramic material is one of an inorganic crystalline oxide material, inorganic non-crystalline oxide material or a combination thereof.

12. The apparatus of claim 10, wherein the ceramic material comprises one or more of quartz, feldspar, kaolin clay, china clay, clay, alumina, silica, mullite, silicate, kaolinite, ball clay, bone ash, steatite, petuntse, alabaster, zirconia, carbide, boride, silicide, and combinations thereof.

13. The apparatus of claim 10, wherein the ceramic material comprises one of silica, alumina and a combination thereof.

14. The apparatus of claim 1, wherein the interconnected pores have an average pore size from about 0.05 μm to about 1.0 μm.

15. A method, comprising:
contacting a monolith having a plurality of interconnected pores with a rare earth-containing solution to form a rare earth impregnated monolith, wherein the interconnected pores form a plurality of fluid pathways and wherein the rare earth is impregnated along substantially the entire lengths of the fluid pathways; and
calcining the impregnated monolith to form a rare earth coated monolith having a plurality of rare earth coated pathways, wherein the coated rare earth is in the form of an insoluble rare earth composition.

16. The method of claim 15, wherein the rare earth-containing solution comprises one of a rare earth carbonate, nitrate, iodate, sulfate, chlorate, bromate, acetate, formate, and oxalate and wherein the rare earth-containing solution is an aqueous solution.

17. The method of claim 16, wherein the rare earth-containing solution comprises one of cerium carbonate, nitrate, iodate, sulfate, chlorate, bromate, acetate, formate, and oxalate.

18. The method of claim 15, wherein the contacting comprises one of spray coating, curtain coating, immersing, kiss-coating, and coating under greater than atmospheric pressure.

19. The method of claim 15, wherein the contacting comprises immersing the monolith in the rare earth-containing solution.

20. The method of claim 19, wherein the immersing is for a period of from about 1 hour to about 48 hours.

21. The method of claim 15, further comprising after the contacting step and before the calcining step, drying the impregnated monolith to form a dried rare film within the interconnected pores of the monolith and wherein the drying period is from about 10 minutes to about 24 hours.

22. The method of claim 15, wherein the calcining step comprises heating the monolith to a temperature of from about 250 degrees Celsius to about 900 degrees Celsius and wherein the monolith is heated in the presence of oxygen.

23. The method of claim 15, wherein the calcining step forms an insoluble rare earth composition, wherein the insoluble composition is within the interconnected pores of the monolith and wherein the insoluble rare earth composition comprises from about 1 wt % to about 65 wt % of the coated monolith.

24. The method of claim 23 wherein the insoluble rare earth composition comprises a film and wherein the film has a film thickness from about 2 nm to about 50 nm.

25. The method of claim 23, wherein the insoluble rare earth composition comprises a film having a film surface area of at least about 5 m² per gram of the monolith.

26. The method of claim 23, wherein the insoluble earth composition comprises particles, and wherein the particles have an average surface area of more than about 115 m²/g.

27. The method of claim 23, wherein the insoluble rare earth oxide film comprises cerium.

28. A process, comprising:
contacting an ingress surface of a porous monolith comprising an insoluble rare earth composition with a contaminant-containing fluid; and
passing the contaminant-containing fluid through the monolith to an egress surface, wherein the passing of the contaminant-containing fluid through the monolith substantially removes one or more of the contaminants contained within the contaminant-containing fluid to form a purified fluid and a contaminant-loaded rare earth composition and wherein the purified fluid exists the monolith at the egress surface.

29. The process of claim 28, further comprising heating at least one of:
i) the contaminant-containing fluid prior to the contacting step; and
ii) the contaminant-containing fluid and the monolith during the contacting step.

30. The process of claim 28, further comprising:
applying pressure to the fluid during the contacting step.

31. The process of claim 28, wherein the one or more contaminants contained within the contaminant-containing fluid are removed by the insoluble rare earth composition.

32. The process of claim 28, wherein the insoluble rare earth composition comprises at least one of cerium (IV) oxide (CeO₂) and cerium (III) oxide (Ce₂O₃).

33. The process of claim 28, wherein at least one of the one or more contaminants comprises one of a chemical contaminant, biological contaminant, microbe, microorganism and a mixture thereof.

34. The process of claim 28, wherein the contaminant-loaded rare earth composition comprises one of REX and REOX, wherein RE comprises a rare earth element, O comprises O²⁻, and X comprises one of a contaminant or residue of the contaminant.

35. The process of claim 28, wherein the contaminant-containing fluid comprises one of liquid fluid, a gaseous fluid, and a combination of liquid and gaseous fluids.

36. The process of claim 28, wherein the porous monolith comprises a porous ceramic having a plurality of pores and a void volume.

37. The process of claim 28, wherein the insoluble rare earth composition is within the pores and void volume of the monolith, wherein the insoluble rare earth composition comprises from about 1 wt % to about 65 wt % of the monolith and wherein the insoluble rare earth composition comprises a film having one or both of a film thickness from about 1 nm to about 50 nm and a film surface area of at least about 5 m² per gram of the monolith.

38. A system, comprising:
a container comprises a housing having opposing first and second ends, an inlet, an outlet, and an outer wall extending between the first and second ends enclosing a fluid flow path between the inlet and the outlet; and
a porous and permeable monolith comprising an insoluble rare earth composition disposed within the hosing, the porous and permeable monolith comprising an insoluble rare earth composition for treating a contaminant-containing fluid, an ingress surface, and egress surface, wherein the ingress and egress surfaces are interconnected by a plurality of fluid pathways extending through the porous monolith and wherein the ingress surface is operably interconnected to the inlet and the egress surface is operably connected to the outlet, whereby the contaminant-containing flows from the inlet and through the ingress surface, the plurality of fluid pathways, and the egress surface for discharge of a purified fluid through the outlet.

39. The system of claim 38, wherein the insoluble comprises at least one of cerium (IV) oxide (CeO₂) and cerium (III) oxide (Ce₂O₃), wherein the insoluble rare earth composition is within the fluid pathways of the monolith, wherein the insoluble rare earth composition comprises from about 1 wt % to about 65 wt % of the monolith and wherein the insoluble rare earth composition comprises a film having one or both of a film thickness from about 2 nm to about 50 nm and a film surface area of at least about 5 m² per gram of the monolith.

40. The system of claim 38, wherein the insoluble rare earth composition comprises one or more of lanthanum, cerium, praseodymium, neodymium, promethium, samarium, europium, gadolinium, terbium, dysprosium, holmium erbium, thulium, ytterbium and lutetium.

41. The system of claim 38, wherein the monolith comprises a ceramic material and wherein the ceramic material is one of an inorganic crystalline oxide material, inorganic non-crystalline oxide material or a combination thereof.

42. The system of claim 38, wherein the container comprises one or more monoliths configured in series, parallel and any combination thereof.

43. The system of claim 38, wherein the container comprises one of a metal, plastic, PVC, and acrylic.
